(19) United States
(12) Patent Application Publication
(10) Pub. No.: US 2017/0224137 A1
(43) Pub. Date: Aug. 10, 2017

(54) INSECT BARRIER AND REPELLANT FABRIC

(71) Applicant: Jeffrey Laurence HARTDORN, New Smyrna Beach, FL (US)

(72) Inventor: Jeffrey Laurence HARTDORN, New Smyrna Beach, FL (US)

(21) Appl. No.: 15/499,114

(22) Filed: Apr. 27, 2017

Related U.S. Application Data
(63) Continuation-in-part of application No. 14/883,928, filed on Oct. 15, 2015.

(51) Int. Cl. A47G 9/00; A41B 1/08; A01N 25/34; D06M 13/224; A01N 53/00; A41D 13/00; A01M 29/12

(52) U.S. Cl. CPC A47G 9/00; A41D 13/001; A41B 1/08; A01M 29/12; D06M 13/2246; A01N 53/00; A01N 25/34

(57) ABSTRACT

An insect barrier and repellant fabric includes a plurality of resilient spacers. Each resilient spacer has a first end secured to a first side of a fabric substrate, and a free second end extending away from the fabric substrate. A pesticide is carried by the plurality of resilient spacers. The pesticide is one of permethrin, deltamethrin or other similar chemical insect repellant. The pesticide may be carried on a surface of the resilient spacers or encapsulated within its structure, for example.

### CROSS-REFERENCE TO RELATED APPLICATION

This application is a continuation-in-part of U.S. patent application Ser. No. 14/883,928 filed Oct. 15, 2015.

### TECHNICAL FIELD

The present invention relates to the field of fabrics, and, more particularly, to an insect barrier and repellant fabric and related methods of manufacturing.

### BACKGROUND

Due in part to globalization, the world has seen increases in vector borne pathogen transmission leading to disease outbreaks such as chikungunya in Latin America and Caribbean in 2013-2014. In addition, there was an outbreak of dengue and Zika virus diseases simultaneously in Brazil in 2015, as well as concurrent malaria resurgence and Yellow Fever outbreaks in Angola, which now is found in DRC, Kenya, and China. According to the CDC, over 3.2 billion people are at risk from mosquito borne malaria with 200 million cases at any one time resulting in 500,00 deaths per year.

Many deterrent methods, both mechanical and chemical, have been used to combat the transmission of vector borne diseases, such as malaria. Insecticide treated nets (ITNs) use both mechanical and chemical means. The net serves a mechanical or physical barrier, and the insecticide serves as the chemical means. The primary chemical in use today is pyrethrin. Pyrethrin is typically obtained from chrysanthemums. Pyrethrin and its synthetically prepared analogs effectively control a variety of pests, such as ticks, cockroaches, houseflies, mosquitoes, and other flying or crawling insects. Pyrethroids are not harmful to plants, food, animals or humans, and leave no harmful residues. Deltamethrin is also an effective deterrent. Pyrethrin has a “knock down” range of 15 inches and was initially applied as a coating to net fibers in a 0.0008% dispersion. Despite these highly favorable characteristics, pyrethrin has had only limited general utility because of its relatively short-lived insecticidal activity. This is due to the decomposition of pyrethrin into a nonactive, non-insecticidal product in the presence of oxygen and ultraviolet light. Washing the nets coated with pyrethrin further degrades its efficacy.

Long lasting insecticide infused nets (LLINs) were developed to extend knock down time and be more resilient to washing. LLIN technology has been the gold standard in malaria prevention for over a decade and is credited with saving millions of lives. LLINs, such as bed nets, are designed to provide protection from nocturnal indoor biting mosquitoes that carry malaria. The LLIN bed nets have been very effective and has resulted in the insects modifying their behavior and are becoming exophilic (day biting). This coincides with other daytime feeding outbreaks. For example, Zika, transmitted by both Aedes aegypti and Aedes albopictus, the same mosquitoes that transmit dengue, chikungunya, Yellow Fever, etc. have shown that the lack of outdoor vector prevention has placed a greater burden on the health system, economy, tourism and household expenditure in affected countries.

Coupled with the economic considerations, the increasing burden of vector borne disease has led to an emphasis on the Global Health Security Agenda and the ever increasing need for new prevention and control tools—especially for personal protection. Protective clothing, as recommended by the CDC, is an excellent part of the overall strategy to combat insect transmitted disease. Innovation, particularly focused on at-risk populations such as military personnel, migrant and forest workers, community health workers, pregnant women, children, the elderly and others such as those with weakened immune systems, is needed to prevent current and future threats. Further, innovation is needed to better serve at-risk populations in situations where chemical repellents, such as DEET, may increase the risk to the user or where specific vectors are present that may not be repelled by chemical means due to increases in insecticide resistance.

U.S. Pat. No. 3,783,451 issued to Malin illustrates a spacing system of tubes and annular rings that are inappropriate for incorporation into an LLIN garment due to the volume of material in contact with the skin of the user since it retains heat, absorbs moisture and is counterproductive in a tropical environment. A shortcoming of Malin's design is that it is uneconomical to manufacture due to waste involved with die stamping plastic or other suitable spacing rings and the time required to align the individual rings on the insect excluding fabric. Further, there is no known practical and permanent method of attaching rings to the fabric. Malin also omits a means for preventing the insect deterring fabric from contacting the skin at areas where the insect fabric is not directly separated from skin by the spacing means. This is a particular problem for articulating areas such as elbows and knees where the fabric has a tendency to collect together allowing the biting insect to reach the skin.

U.S. Pat. No. 5,214,797 to Tisdale discloses a method of stitching a plurality of reticulated elongated polyurethane foam strips to a substrate. This too has proven uneconomical to manufacture, since it requires stitching and places an enormous volume of material against the skin of the user, which retains heat, absorbs moisture and is counterproductive in a tropical environment.

Therefore, a need exists for a fabric to combat insects, such as mosquitos, that are known to transmit diseases in the tropics and elsewhere that is cool and inexpensive to manufacture.

### SUMMARY

An insect barrier and repellant fabric is disclosed. The insect barrier and repellant fabric includes a plurality of resilient spacers. Each resilient spacer has a first end secured to a first side of a fabric substrate, and a free second end extending away from the fabric substrate. A pesticide is carried by the plurality of resilient spacers. The pesticide is one of permethrin, deltamethrin or other similar chemical insect repellant. The pesticide may be carried on a surface of the resilient spacers or contained within its structure, for example.

The resilient spacers are approximately 9.5 mm in length along a respective longitudinal axis. One end attaches, by mechanical or chemical means, to the fabric substrate, such as a net material. The resilient spacers work in concert with each other to increase the surface area of permethrin treated fabric and vary slightly in their height, sequencing and separation according to the substrate to which they are attached. When attached to lightweight mosquito net, the resulting fabric virtually floats over the surface of the skin and when incorporated into garments, uniforms, blankets, sleeping bags and other products, affords both a primary and a secondary level of vector protection by inhibiting the biting of vector and nuisance mosquitoes. The spacers return to their original shape after being compressed.

A method for increasing the efficacy of LLIN (Long Lasting Insecticidal Nets) utilizing a plurality of insecticide-infused spacers. The spacer, attached to the substrate by mechanical means, has been specifically engineered to be receptive to the incorporation of microencapsulated permethrin, or other insecticide. Simultaneously, the spacers hold the substrate material at a sufficient height above a surface to prevent the penetration of the proboscis of a mosquito.

### BRIEF DESCRIPTION OF THE DRAWINGS

FIG. 1 is a front view of a particular embodiment of an insect barrier and repellant fabric;

FIG. 2 is a top partial view of the insect barrier and repellant fabric of FIG. 1;

FIG. 3 is a partial cross sectional view taken along the line 3-3 of FIG. 2;

FIG. 4 is a partial perspective view of insect barrier and repellant fabric;

FIG. 5 is a perspective detail view of a spacer of the insect barrier and repellant fabric; and

FIG. 6 is a cross sectional view of the spacer in the direction of line 6-6 of FIG. 5.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

In a particular embodiment, a number of resilient spacers are used to increase the efficacy of long lasting insecticidal nets (LLINs), or other netting material, by increasing the surface area for pesticide disbursement and separating a net substrate from the human skin. The spacer, affixed to the net substrate, is configured to carry on its surface or contained within its structure, permethrin, deltamethrin or other pesticide.

Permethrin is a synthetic pyrethroid which exhibits repellent as well as knockdown and kill activity against insects. Pyrethroids, including both the naturally occurring compounds and their synthetically prepared analogs effectively control a variety of pests, such as ticks, cockroaches, houseflies, mosquitoes, and other flying or crawling insects. Pyrethroids are not harmful to plants, food, animals or humans, and leave no harmful residues. The fabric substrate may be dyed and finished in the normal manner and then treated with polyvinylacetate, after which the fabric substrate is treated with permethrin. A 0.008% permethrin dispersion, as allowed by Environmental Protective Agency, provides an initial concentration in a selected fabric substrate of approximately 1.25 grams of permethrin per square meter.

Each of the resilient spacers may be approximately 9.5 mm on its longitudinal axis. One end attaches, by mechanical or chemical means, to the fabric (e.g. netting) substrate. The resilient spacers work in concert with each other to increase the surface area of permethrin treated fabric and vary slightly in their height, sequencing and separation according to the substrate to which they are attached.

When the resilient spacers are attached to a lightweight mosquito net, the resulting fabric virtually floats over the surface of the skin. In addition, when incorporated into garments, uniforms, blankets, sleeping bags and other products, it affords both a primary and a secondary level of vector protection by inhibiting the biting of vector and nuisance mosquitoes. The resilient spacers may be comprised of a resilient material and return to their original shape after being compressed.

A method for manufacturing an LLIN having an increase efficacy includes utilizing a plurality of insecticide-infused resilient spacers as described above. The resilient spacers are attached to the substrate by mechanical means and are specifically engineered to be receptive to the incorporation of microencapsulated permethrin, or other insecticide. The resilient spacers suspend the substrate material at a sufficient height above the skin to prevent the penetration of the proboscis of a mosquito.

One embodiment of the instant invention uses a spacer having a shape of an inverted cone. Only the tip of the inverted cone is in contact with the skin of the user. The top of the spacer can be wider than the bottom to maximize the upper surface area for chemical or mechanical adhesion to the substrate. The bottom of the inverted cone provides the least possible surface area contact with the skin of the wearer. In tests, a diamond pattern of resilient spacers, separated by a distance of 1.5 to 2.1 cm provided sufficient height to prevent the penetration of a mosquito's proboscis' on the areas of compression such as the elbows and at the intersection with hard surfaces, such as a chair.

The resilient spacers may comprise a resilient yet compressible material, and have a longitudinal length (or height) between 6.35 mm and 19.1 mm and have a diameter between 3 mm to 20 mm. The spacer may be configured to be infused with, or carry on its surface, permethrin, deltamethrin or other pesticide. The spacer, when attached to an LLIN substrate, significantly enhances LLIN efficacy and assists in the battle against vector borne diseases.

The resilient spacers may incorporate the same permethrin micro-encapsulation technology as in the nylons, polyurethanes and other synthetics used in the net substrate. The spacer may be economically affixed to LLINs using existing techniques.

One embodiment incorporates medium density, hydrophilic thermoplastic memory foam that is derived from various kinds of polymer materials, such as a rubber, an elastomer, a thermoplastic resin, and a thermosetting resin, or the like. Examples of the polymer materials include natural rubbers, synthetic rubbers such as chloroprene rubber, styrene butadiene rubber, an nitrile-butadiene rubber, an ethylene-propylene-diene terpolymer copolymer, a silicone rubber, a fluoride rubber, and an acrylic rubber. An example of an elastomer is soft urethane, and examples of thermosetting resins include hard urethane, a phenolic resin, and a melamine resin, but not limited thereto.

In the case that a synthetic rubber is used for the resilient spacers, it may be used as a base foam material after cross-linking. However, a base foam material made of a thermosetting resin or a cross-linked rubber may be problematic since it has a slight rigidity change at room temperature and at the time of heating. A foam material containing a soft urethane as the main component is relatively inexpensive, and used widely as a cushion material so as to be easily accessible, and is preferable as a base foam material. Furthermore, even in the case of a foam material made of a thermoplastic resin, it can be used as a base foam material as long as the softening temperature thereof is higher than the softening temperature of a thermoplastic substance for the impregnation therein with micro-encapsulated permethrin.

The resilient spacers may be comprised of thermoplastic resins such as a polyethylene, polypropylene, polystyrene, polyvinyl chloride, polyvinylidene chloride, polyvinyl acetate, polyacrylate, styrene-butadiene copolymer, chlorinated polyethylene, polyvinylidene fluoride, ethylene-vinyl acetate copolymer, ethylene-vinyl acetate-vinyl chloride-acrylate copolymer, ethylene-vinyl acetate-acrylate copolymer, ethylene-vinyl acetate-vinyl chloride copolymer, nylon, an acrylonitrile-butadiene copolymer, polyacrylonitrile, polyvinyl chloride, polychloroprene, polybutadiene, thermoplastic polyimide, polyacetal, polyphenylene sulfide, polycarbonate, and thermoplastic polyurethane. Thermoplastic compounds of the resilient spacers may include a low melting point glass frit, for example, or starch, solder, and wax. However, the composition of the resilient spacers is not intended to be limited to those components listed here.

Hydrophilic foams tend to be comfortable to the touch and resist wicking perspiration from the skin into the spacer and substrate. In addition, polymers of polyethylene, polypropylene, polystyrene and polyurethane and the memory foams created therefrom are biodegradable by the complete or partial esterification of embedded polysaccharides. This would address a concern of many Sub-Saharan countries. The resilient spacers are configured based in part on the chemical and physical properties of the net substrate, which can vary from natural fibers to complex polymers.

Referring initially to FIG. 1, the insect barrier and repellant fabric 100 increases the ability of the wearer 102 to avoid the stings and bites of insects while remaining cool and well ventilated. In this particular embodiment, the insect barrier and repellant fabric 100 has been made into a shirt having arm sleeves 104 and a neck opening 106. The insect barrier and repellant fabric 100 includes a plurality of resilient spacers 108.

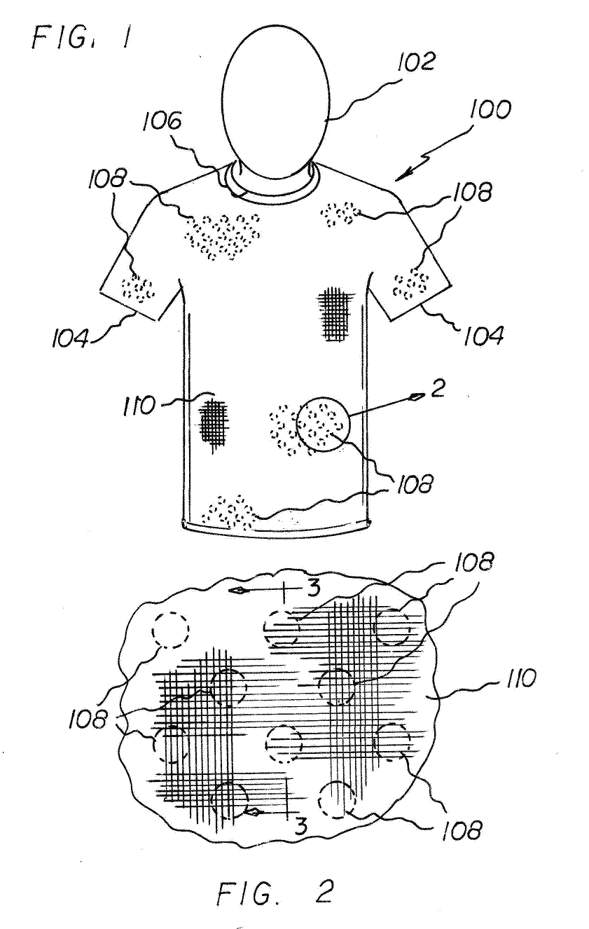

Referring now to FIG. 2, the insect barrier and repellant fabric 100 may include a fabric substrate 110 having the plurality of resilient spacers 108 connected to the fabric substrate 110 itself, where each spacer 108 is defined by a cone shape having a top (first) end coupled to the fabric substrate 110 and a converging bottom (second) end that is free. A pesticide coating may be formed over a surface of each of the resilient spacers 108 in order to repel insects. The fabric substrate 110 may be a mesh material similar to that used currently as mosquito netting.

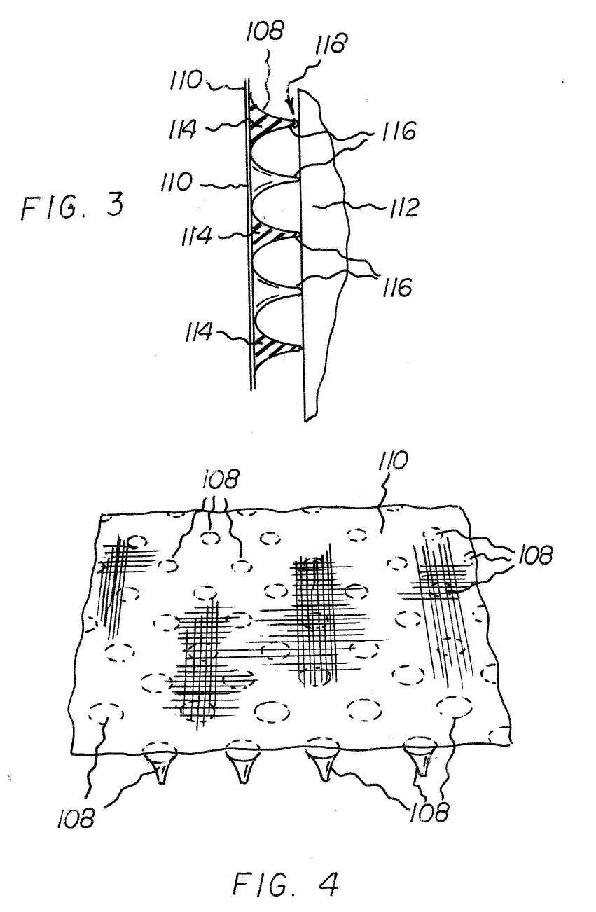

As illustrated in FIG. 3, the plurality of resilient spacers 108 are configured to suspend the fabric substrate 110 away from a respective surface such as the skin 112 of the wearer 102. The top end 114 of the spacer 108 narrows to a converging bottom end 116 and a tip 118 that is the only portion of the spacer 108 that touches the skin 112 of the wearer 102. The diameter of the resilient spacers 108 may be between about 3 mm and 20 mm.

Referring now to FIG. 4, the plurality of resilient spacers 108 are arranged in rows and columns to form a diamond pattern within the fabric substrate 110. The spacing between the resilient spacers 108 may depend on the rigidity of the fabric substrate 110, but generally a spacing of about 1.5 cm to 2.1 cm, for example, and arranged in a diamond pattern is sufficient to maintain the distance of the fabric substrate 110 above the skin 112 to protect against insect bites.

The insect barrier fabric 100 may include a woven or non-woven mesh substrate 110, and incorporating on its surface the regularly interspaced pattern of resilient spacers 108. The resilient spacers 108 may be chemically (e.g., adhesives) or mechanically (e.g., sewn) connected to the fabric substrate 110 itself, for the purpose of elevating the insect barrier fabric 100 sufficiently above the skin 112 of the wearer 102 to establish a space through which insects cannot sting or bite, or about 9.6 mm in a particular embodiment. The spacer 108 is impervious to penetration by insects. As explained above, the insect barrier and repellant fabric 100 is suitable for the production of, or incorporation into, garments, bed covers, and sleeping bags.

Accordingly, the insect barrier and repellant fabric 100 may be manufactured using a unique process of mosquito netting material, of natural or synthetic composition, into a configuration that creates a space between the skin 112 of the wearer and attacking insects. Incorporated on and extending beneath the fabric substrate 110 of the insect barrier fabric 100 is a repeating pattern of the resilient spacers 108. In general, mosquitoes and insects can easily penetrate existing mosquito netting. The space created between the fabric substrate 110 and the skin 112 of the wearer 102 may be used to separate the barrier surface of the insect barrier fabric 100 from the skin.

The tip 118 of the spacer 108 can rest on the skin 112 of the wearer 102 and the height of its vertical axis will determine the surface height of the fabric substrate 110 thus suspended. The lateral distance between the resilient spacers 108, shown in FIG. 4, may be selected based on the rigidity of the substrate 110, but generally a spacing of 1.5 cm to 2.1 cm arranged in a diamond pattern is sufficient to keep the surface of the substrate 110 a constant height of about 6.35 mm and 19.1 mm, in a particular embodiment. The insect barrier fabric 100 is suitable for clothing, bed covering, sleeping bags or any other application that would benefit from the improvement.

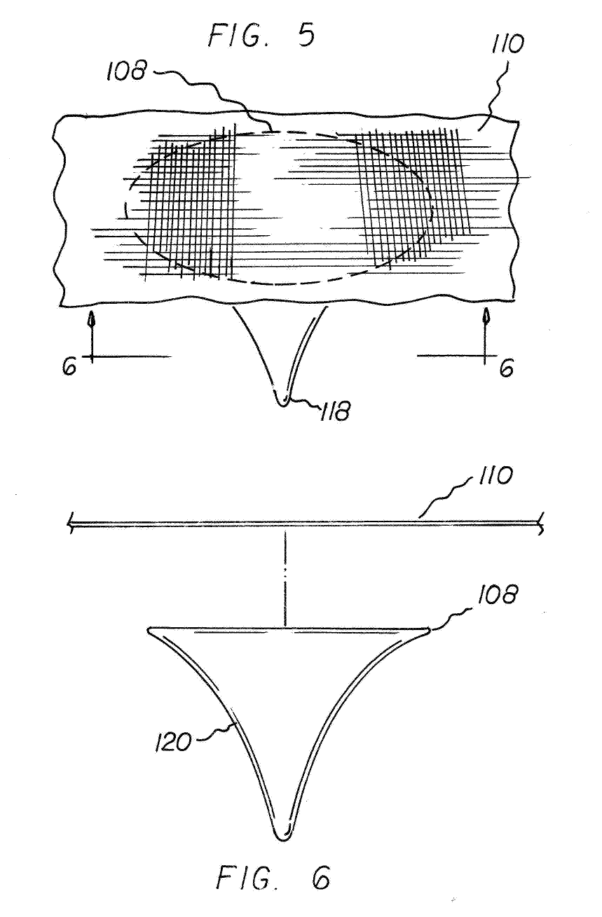

Referring now to FIGS. 5 and 6, in the event an aggressive insect or mosquito attempts to crawl through the fabric substrate 110, the resilient spacers 108 are coated and/or encapsulated with a pesticide 120 that becomes an essential element of the spacer 108.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An insect barrier and repellant fabric comprising:
a fabric substrate having a first side and a second side; and
a plurality of resilient spacers, each resilient spacer having a first end secured to the first side of the fabric substrate, and a free second end extending away from the fabric substrate.

2. The insect barrier and repellant fabric of claim 1, further comprising a pesticide carried by the plurality of resilient spacers.

3. The insect barrier and repellant fabric of claim 1, wherein a length of the plurality of resilient spacers is between 6.35 mm and 19.1 mm.

4. The insect barrier and repellant fabric of claim 1, wherein a diameter of each of the plurality of resilient spacers is between 3 mm and 20 mm.

5. The insect barrier and repellant fabric of claim 1, wherein each of the plurality of resilient spacers is spaced apart from one another on the fabric substrate between 1.5 and 2.1 cm.

6. The insect barrier and repellant fabric of claim 1, wherein the fabric substrate comprises a mesh material.

7. The insect barrier and repellant fabric of claim 2, the pesticide is encapsulated within the plurality of resilient spacers.

8. The insect barrier and repellant fabric of claim 2, wherein each of the resilient spacers is coated with the pesticide.

9. The insect barrier and repellant fabric of claim 2, wherein the pesticide is carried by the fabric substrate and the plurality of resilient spacers.

10. The insect barrier and repellant fabric of claim 2, wherein the pesticide is one of permethrin and deltamethrin, or any combination thereof.

11. The insect barrier and repellant fabric of claim 1, wherein the plurality of resilient spacers comprise hydrophilic foam.

12. An insect barrier and repellant fabric comprising:
a mesh fabric having a first side and a second side; and
a plurality of hydrophilic resilient spacers, each hydrophilic resilient spacer having a first end secured to the first side of the mesh fabric, and a free second end having a diameter smaller than the first end and extending away from the mesh fabric.

13. The insect barrier and repellant fabric of claim 12, further comprising a pesticide carried by the plurality of hydrophilic resilient spacers and mesh fabric.

14. The insect barrier and repellant fabric of claim 12, wherein a length of each of the plurality of resilient spacers is between 6.35 mm and 19.1 mm.

15. The insect barrier and repellant fabric of claim 12, wherein a diameter of each of the plurality of resilient spacers is between 3 mm and 20 mm.

16. The insect barrier and repellant fabric of claim 12, wherein each of the plurality of resilient spacers is spaced apart from each adjacent resilient spacer on the mesh fabric between 1.5 and 2.1 cm.

17. The insect barrier and repellant fabric of claim 13, the pesticide is encapsulated within the plurality of resilient spacers.

18. The insect barrier and repellant fabric of claim 13, wherein the pesticide is one of permethrin and deltamethrin, or any combination thereof.

19. A method to manufacture an insect barrier and repellant fabric comprising:
applying a pesticide to a plurality of resilient spacers; and
securing a first end of each resilient spacer of the plurality to a mesh fabric.

20. The method to manufacture the insect barrier and repellant fabric of claim 19, the plurality of resilient spacers comprise hydrophilic foam.
